(19) United States
(12) Patent Application Publication
(10) Pub. No.: US 2015/0243411 A1
(43) Pub. Date: Aug. 27, 2015

(54) COOLING APPARATUS FOR ELECTRICAL WIRE

(71) Applicant: SUMITOMO WIRING SYSTEMS, LTD., Yokkaichi (JP)

(72) Inventor: Takamasa MAEDA, Yokkaichi (JP)

(21) Appl. No.: 14/624,806

(22) Filed: Feb. 18, 2015

(30) Foreign Application Priority Data
Feb. 25, 2014 (JP) 2014-034377

(51) Int. Cl. H01B 7/42; F28D 1/00

(52) U.S. Cl. CPC H01B 7/423; F28D 1/00

(57) ABSTRACT

Described are electrical wires accommodated inside a shield tube to be cooled down. A plurality of electrical wires 3 connecting a motor 1 and an inverter 2, and cooling tubes 7 thorough which coolant flows are inserted through a shield tube 4. The electrical wires 3 are gathered at the center of the shield tube 4, and three cooling tubes 7 are arranged so as to surround the electrical wires 3 from the outer side. Furthermore, the cooling tubes 7 are connected to a circulating circuit C of coolant for cooling down an engine 9.

### TECHNICAL FIELD

The present disclosure relates to a cooling apparatus for an electrical wire.

### BACKGROUND ART

Conventionally, in order to protect a wire harness constituted by a plurality of electrical wires arranged in an automobile from external interference members or the like, the wire harness is inserted through an external cover material made of a resin tube, for example, as in JP H9-107615A noted below. JP 2003-348736A noted below uses an accordion-like grommet made of an elastic material such as rubber, as an external cover material in which a wire harness that may be bent or twisted is inserted and protected.

JP H9-107615A and JP 2003-348736A are examples of related art.

### BRIEF SUMMARY

Meanwhile, a wire harness arranged, for example, between a motor and an inverter or between a battery and an inverter of, for example, electric automobiles or hybrid automobiles, may be problematic in that the temperature of the electrical wires may significantly increase. The reason for this is that the amount of heat generated by the electrical wires increases because the amount of current that flows therethrough is large. In addition, the temperature around the electrical wires also increases when the wire harness is inserted through an external cover material because heat is accumulated in an air layer formed inside the external cover material. In order to solve this problem, use of electrical wires having a high upper temperature limit, or use of electrical wires having a large wire diameter, is to some extent effective. However, the use of electrical wires having a high upper temperature limit increases the cost, and the use of electrical wires having a large wire diameter increases the weight, and requires a large arrangement space, which may cause a problem in the layout.

The present disclosure was made in view of these circumstances, and it is an object thereof to provide a cooling apparatus for electrical wires that is capable of effectively cooling down electrical wires that generate heat.

The present embodiment is directed to a cooling apparatus for cooling down an electrical wire connecting, for example, a motor and a unit that supplies electric power to the motor mounted in, for example, a hybrid automobile or an electric automobile, the cooling apparatus including: a shield tube through which the electrical wire can be inserted in an electrically shielded state, wherein a cooling path through which a cooling fluid for cooling down the electrical wire flows is formed inside the shield tube.

The electrical wires connecting the motor and the unit may generate heat in accordance with the application of electricity, for example, to the motor. However, the cooling fluid inside the shield tube effectively suppresses generation of heat by the electrical wires. Accordingly, the peripheral members including the electrical wires do not have to be made of high heat-resistance materials.

### BRIEF DESCRIPTION OF THE DRAWINGS

FIG. 1 is a diagram showing the outline of the entire cooling apparatus of Example 1.

FIG. 2 is a cross-sectional view showing the internal structure of a shield tube.

FIG. 3 is a cross-sectional view showing the internal structure of a shield tube of Example 2.

### DETAILED DESCRIPTION

Hereinafter, preferred embodiments of the present disclosure will be described.

(1) In the cooling apparatus of the present disclosure, in a preferred embodiment, the cooling path is connected to a circulating circuit of coolant for the motor or an engine.

With this configuration, an existing circulating circuit of coolant can be used for cooing down the electrical wire. Furthermore, since the coolant can be circulated, the electrical wire can be effectively cooled down.

(2) Furthermore, in the preferred embodiment, a cooling tube functioning as the cooling path is inserted together with the electrical wire through the shield tube, and the cooling tube is disposed in contact with the electrical wire along an axial direction, for example, substantially along an axial direction.

With this preferred embodiment, the cooling tube can cool down the electrical wire in the axial direction, for example, substantially in the axial direction, inside the shield tube. Thus, the electrical wire can be efficiently cooled down.

(3) Furthermore, it is possible that a plurality of the electrical wires are inserted through the shield tube, the electrical wires are arranged so as to be gathered, for example, at the center of the shield tube, and a plurality of the cooling tubes are arranged so as to surround the electrical wires from the outer side.

With this embodiment, the plurality of electrical wires gathered at the center of the shield tube can be cooled down from the outer side, and, thus, transmission of heat to the shield tube can be suppressed.

(4) Furthermore, it is possible that at least one of the cooling tubes is disposed along the axial direction at the center of the shield tube, a plurality of the electrical wires are inserted through the shield tube, and the electrical wires are arranged so as to surround the cooling tube from the outer side.

With this embodiment, the cooling tube is positioned inside the electrical wires, and, thus, accumulation of heat in a space surrounded by the electrical wires can be suppressed.

Next, Examples 1 and 2 of embodiments of the cooling apparatus for electrical wires according to the preferred embodiment will be described with reference to the drawings.

### Example 1

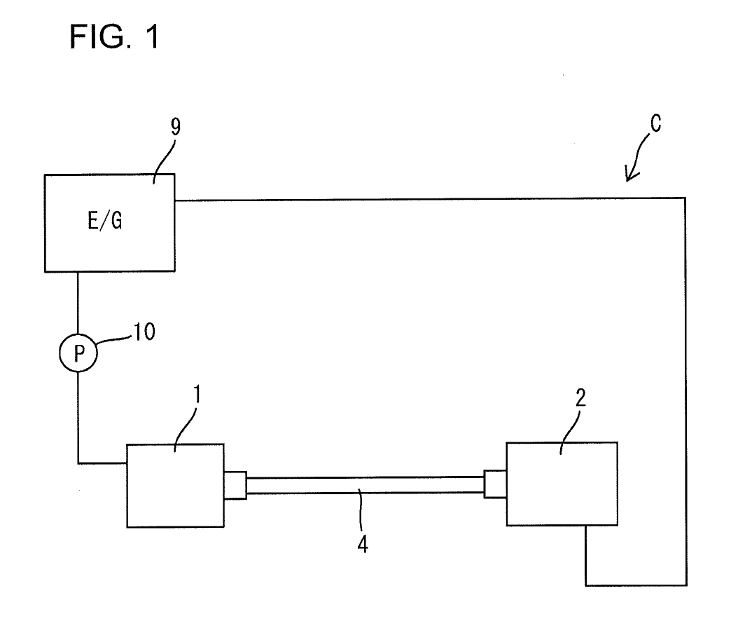

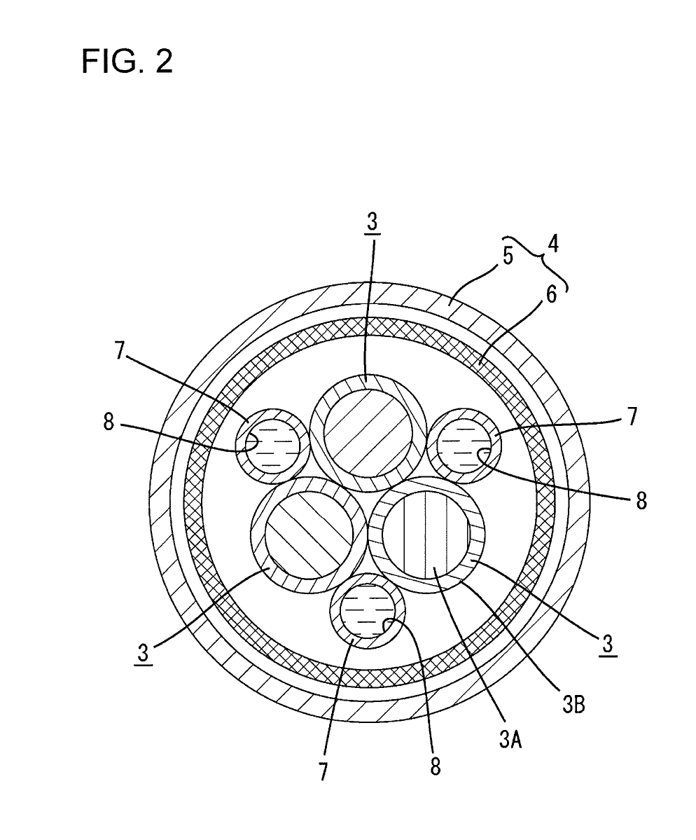

FIGS. 1 and 2 show Example 1 of the preferred embodiment. FIG. 1 shows the overall configuration in which the cooling apparatus of the preferred embodiment may be applied to a hybrid automobile. A motor 1 and an inverter 2 (corresponding to the “unit” of the preferred embodiment) are mounted in an engine room of the automobile, and are connected as shown in FIG. 2 by a plurality of (for example three, as illustrated in the drawing) electrical wires 3. The electrical wires 3 are inserted through a shield tube 4.

As shown in FIG. 2, the shield tube 4 has a protective tube 5 as an exterior component. For example, the protective tube 5 may be made of resin, for example, a synthetic resin, and may be in the shape of a pipe having a substantially circular cross-section. The protective tube 5 may be flexible, and can be deflected into a predetermined shape.

The above-described electrical wires 3 may be inserted in the axial direction through the protective tube 5. The electrical wires 3 may be inserted through a braided member 6 inserted through the protective tube 5. The braided member 6 may be obtained by, for example, knitting a large number of thin metal wires into a tubular shape. The braided member 6 together with the protective tube 5 may form the shield tube 4, and may prevent noise superimposed on the electrical wires 3 from being emitted out of the shield tube 4.

Although not shown in detail in the drawings, the braided member 6 together with the electrical wires 3 may project from both ends in the axial direction of the protective tube 5. The electrical wires 3 that may project from both ends of the axial direction of the protective tube 5 may be electrically connected to the inverter 2 and the motor 1, and may be shielded by the braided member 6 that may project from both ends of the axial direction of the protective tube 5.

As shown in FIG. 2, the electrical wires 3 may have substantially the same wire diameter, and may be formed by a wire core portion 3A and a coating portion 3B. The electrical wires 3 may be bundled together with, for example, three cooling tubes 7 (inside of which are formed cooling paths 8) so as not to be separated from each other inside the protective tube 5. For example, an adhesive, for example, tape may be wound around the electrical wires 3 and the cooling tubes 7 at appropriate intervals in the length direction, so that the arrangement of the electrical wires 3 and the cooling tubes 7 may be maintained. In the preferred embodiment, the electrical wires 3 are gathered at the center of the protective tube 5 inside the protective tube 5, and the outer circumferential faces of the coating portions of the electrical wires 3 are in contact with each other along the length direction. Accordingly, in the preferred embodiment, the central axes of the electrical wires 3 are positioned substantially at the vertices of triangle, for example, an equilateral triangle. Furthermore, the cooling tubes 7 may be arranged so as to surround the electrical wires 3 from the outer side. The central axes of the cooling tubes 7 may be positioned substantially at the vertices of a triangle, for example, an equilateral triangle. Each of the electrical wires 3 may be held between, for example, two cooling tubes 7 in the diameter direction, and the centers of the two cooling tubes 7 and the electrical wire 3 may be on the same straight line.

The cooling tubes 7 may be made of long pipes having an outer diameter that may be slightly smaller than that of the electrical wires. The cooling tubes 7 may be made of a heat-resistant, pressure-resistant, and/or flexible material.

As shown in FIG. 1, the cooling tubes 7 may be installed in a circulating circuit C of coolant for cooling down an engine 9 mounted in the automobile. An existing circuit for cooling down an engine may be used as this circulating circuit C, and this circuit may be configured such that a circuit connecting the cooling tubes 7 may be branched from the existing circuit. Furthermore, a circulating pump 10 and a radiator (not shown) may be arranged in the circulating circuit C, and circulate the coolant flowing through the cooling tubes 7.

According to Example 1 having the above-described configuration, the following working effects can be achieved. When electricity is applied to the motor 1, the electrical wires 3 inserted through the shield tube 4 generate heat. On the other hand, when the circulating pump 10 is driven, the coolant may be circulated in the circulating circuit C, and flows through the cooling tubes 7. As shown in FIG. 2, each of the cooling tubes 7 may be in contact with the outer circumferences of two adjacent electrical wires 3, and, thus, each of the electrical wires 3 may be cooled down from both sides substantially with respect to the central axis. Accordingly, the electrical wires 3 may be cooled down with almost no unevenness in the temperature along the axial direction.

Furthermore, the coolant flowing through the cooling tubes 7 may be circulated, and the temperature thereof may be set to be not greater than a certain temperature, so that generation of heat by the electrical wires 3 can be effectively suppressed. Furthermore, since an existing circuit for cooling down the engine 9 may be used as the circulating circuit C, a cooling apparatus for the electrical wires 3 can be realized at low cost.

### Example 2

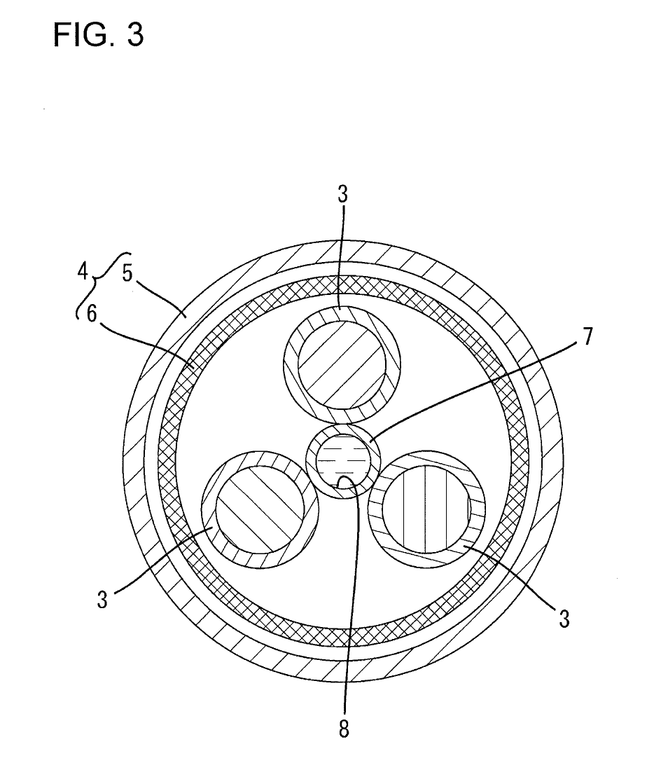

FIG. 3 shows Example 2 according to another preferred embodiment. Example 2 is different from Example 1 in the arrangement of the electrical wires 3 and the cooling tube 7 inside the shield tube 4. One cooling tube 7 may be inserted through the shield tube 4, and may be positioned such that the central axis of the cooling tube 7 matches the central axis of the shield tube 4. The electrical wires 3 may be arranged substantially at equiangular intervals around the cooling tube 7 so as to be in contact with the cooling tube 7. The electrical wires 3 may not be in contact with each other.

Tape may be wound around the electrical wires 3 and the cooling tube 7 at equal intervals in the length direction, so that the arrangement state shown in FIG. 3 may be maintained. The other portions of the configuration may be the same as those in Example 1, and, thus, they are denoted by the same reference numerals, and a description thereof has been omitted.

In the cooling apparatus according to Example 2 having the above-described configuration, the electrical wires 3 may be radially arranged around, for example, one cooling tube 7. That is to say, one cooling tube 7 may be shared by a plurality of electoral wires 3, for example, three electrical wires 3 for cooling down the electrical wires 3, and, thus, the arrangement space can be made smaller than that in Example 1. Accordingly, the diameter of the shield tube 4 may be made smaller.

The other portions of the configuration may be the same as those in Example 1, and, thus, similar working effects can be achieved.

### Other Examples

The present disclosure is not limited to the foregoing description, embodiments, preferred embodiments, and drawings that have been described above. For example, embodiments as described below are also embraced within the technical scope of the present disclosure, and the disclosure is not limited to the following embodiments.

(1) In Example 1 above, tape may be wound around the electrical wires 3 and the cooling tubes 7, so that a predetermined arrangement structure is maintained. However, the tape may not be used. Instead, the braided member 6 may be used for bundling so as to maintain the predetermined arrangement structure. With this configuration, the process that winds tape can be omitted, and, thus, the production time and the cost can be reduced.

(2) In Example 1, a cooling tube 7 may be additionally disposed at the position at the central axis of the shield tube 4. With this configuration, the effect of cooling down the electrical wires 3 can be further improved.

(3) In Examples 1 and 2 above, the cooling tubes 7 are inserted through the shield tube 4. However, the cooling tubes 7 may not be used. Instead, an internal space of the protective tube 5 may be used as the cooling paths 8 through which coolant directly flows inside the protective tube 5.

(4) In the examples above, the electrical wires 3 connecting the motor 1 and the inverter are cooled down. However, electrical wires 3 connecting the motor 1 and a control unit may be cooled down by the cooling apparatus of the present embodiment.

(5) In the examples above, the number of electrical wires 3 inserted through the shield tube 4 is three, but there is no limitation to this.

(6) In the examples above, the shield tube 4 is configured by the protective tube 5 that may be made of a synthetic resin and the braided member 6 inserted through the protective tube 5. However, the shield tube 4 may be formed in one piece from metal. Furthermore, the shield tube 4 be configured such that a metal shield layer may be embedded in the protective tube 5 made of resin, for example, synthetic resin.

(7) In the examples above, the cooling tubes may be connected to an existing circulating circuit of coolant. However, the cooling tubes may be connected to a dedicated circulating circuit. The medium for cooling down is not limited to water, and various cooling fluids may be used.

What is claimed is:

1. A cooling apparatus for cooling down an electrical wire, the cooling apparatus comprising:
a shield tube through which the electrical wire can be inserted in an electrically shielded state,
wherein a cooling path through which a cooling fluid for cooling down the electrical wire flows is formed inside the shield tube.

2. The cooling apparatus for an electrical wire according to claim 1, wherein the cooling path is connected to a circulating circuit of coolant for a motor or an engine.

3. The cooling apparatus for an electrical wire according to claim 1, wherein a cooling tube functioning as the cooling path is inserted together with the electrical wire through the shield tube, and the cooling tube is disposed in contact with the electrical wire substantially along an axial direction.

4. The cooling apparatus for an electrical wire according to claim 3, wherein a plurality of the electrical wires are inserted through the shield tube, the electrical wires are arranged so as to be gathered at the center of the shield tube, and a plurality of the cooling tubes are arranged so as to surround the electrical wires from the outer side.

5. The cooling apparatus for an electrical wire according to claim 3, wherein at least one the cooling tubes is disposed along the axial direction at the center of the shield tube, a plurality of the electrical wires are inserted through the shield tube, and the electrical wires are arranged so as to surround the cooling tube from the outer side.

6. The cooling apparatus for an electrical wire according to claim 2, wherein a cooling tube functioning as the cooling path is inserted together with the electrical wire through the shield tube, and the cooling tube is disposed in contact with the electrical wire substantially along an axial direction.

7. The cooling apparatus for an electrical wire according to claim 4, wherein at least one the cooling tubes is disposed along the axial direction at the center of the shield tube, a plurality of the electrical wires are inserted through the shield tube, and the electrical wires are arranged so as to surround the cooling tube from the outer side.

8. The cooling apparatus for an electrical wire according to claim 1, wherein the electrical wire connects a motor and a unit that supplies electric power to the motor.

9. The cooling apparatus for an electrical wire according to claim 8, wherein the motor is mounted in a hybrid automobile or an electric automobile
